(19) United States
(12) Patent Application Publication
(10) Pub. No.: US 2015/0081489 A1
(43) Pub. Date: Mar. 19, 2015

(54) TIERED CHARGING ALTERATION

(71) Applicant: Oracle International Corporation, Redwood Shores, CA (US)

(72) Inventor: Madhusudan CHAKRAVARTHY, Austin, TX (US)

(73) Assignee: Oracle International Corporation, Redwood Shores, CA (US)

(21) Appl. No.: 14/102,604

(22) Filed: Dec. 11, 2013

Related U.S. Application Data
(60) Provisional application No. 61/879,828, filed on Sep. 19, 2013.

(51) Int. Cl. G06Q 20/14

(52) U.S. Cl. CPC G06Q 20/145
USPC 705/34

(57) ABSTRACT

A system determines a tiered charging rule with at least one step. Each step defines a quantity entry point and exit point for the step and defines an alteration rule to be applied to charges falling within the step. The system determines a quantity usage range based on usage related to a billing event. The system range intersects each step range with the quantity usage range to determine applicable steps for the quantity usage range. For each applicable step, the system calculates a step charge based on the length of the applicable step range and a base per unit charge rate and applies an alteration to the step charge based on the corresponding alteration rule for the step.

### CROSS REFERENCE TO RELATED APPLICATIONS

This application claims priority of U.S. Provisional Patent Application Ser. No. 61/879,828, filed on Sep. 19, 2013, the contents of which is hereby incorporated by reference.

### FIELD

One embodiment is directed generally to a billing and revenue management system, and in particular to a charging system that defines charging tiers for fee alterations.

### BACKGROUND INFORMATION

Sellers of services may commoditize their services based on usage and availability. For example, a telephone service may charge less for calls originating after 9:00 PM than calls originating at 6:00 PM. Other sellers may want to provide discounts for prolonged usage and charge less per unit the more units are sold. For example, a record retrieval service may charge $0.20 per page for the first 100 pages and $0.10 per page for any pages in excess. Still other sellers may want to charge a flat rate for access to services up to a certain unit quantity, and then charge for additional quantities either as needed or in block quantity at a cost per unit exceeding the normal per unit cost. For example, a cell phone provider may charge a monthly access fee for data up to a certain amount and a flat rate for blocks of data exceeding the subscribed amount. In another example, a cell phone provider may charge a monthly access fee for phone call minutes up to a certain amount and a per minute rate for minutes in excess of the plan. Developing algorithms for altering charging can be tricky and complex.

### SUMMARY

In one embodiment a system determines a tiered charging rule with at least one step. Each step defines a quantity entry point and exit point for the step and defines an alteration rule to be applied to charges falling within the step. The system determines a quantity usage range based on usage related to a billing event. The system range intersects each step range with the quantity usage range to determine applicable steps for the quantity usage range. For each applicable step, the system calculates a step charge based on the length of the applicable step range and a base per unit charge rate and applies an alteration to the step charge based on the corresponding alteration rule for the step.

### BRIEF DESCRIPTION OF THE DRAWINGS

FIG. 1 is a block diagram of a computer server/system in accordance with an embodiment of the present invention.

FIG. 2 is a block diagram illustrating an operational flow in accordance with one embodiment.

FIG. 3 is a flow diagram of the functionality of a tiered charging alteration management module of FIG. 1 when processing charging events in accordance with one embodiment.

FIG. 4 is a flow diagram of the functionality of the tiered charging alteration management module of FIG. 1 when processing charging events having multiple charge periods in accordance with one embodiment.

### DETAILED DESCRIPTION

One embodiment receives billing event data related to a quantity usage processed by a charging engine resulting in a corresponding fee. The system applies an alteration to the fee based on a tiered alteration rule. Each step of the rule defines a condition where the fee associated with quantity qualifiers should be altered based on the satisfaction of the condition. Each of the step conditions are represented by quantity range values that define entry and exit quantities for the steps. The system represents the quantity usage as a range value and intersects the usage range value with step range values for each step of the tiered charging rule to determine the applicable step ranges that can have altered billing amounts. The system proportionally distributes the billing data to each step for each of the charge periods from the charging engine by intersecting the quantity range for each charge period with the applicable step range. The system can associate each charge period relative to each other to eliminate any gaps in charge periods. The system identifies the quantity range of each charging period within the step and determines a base charge based on a per unit cost and applies an alteration rule based on the step of the alteration tier in which the charging periods were found.

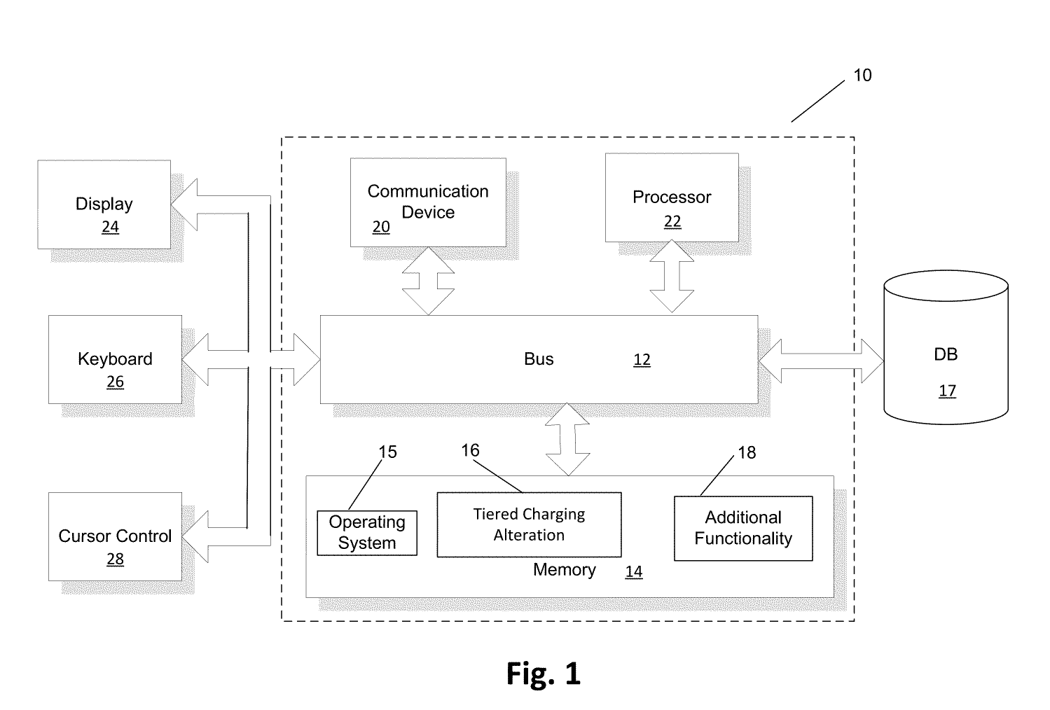

FIG. 1 is a block diagram of a computer server/system 10 in accordance with an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other known method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a tiered charging alteration module 16 that provides and processes charging data, as disclosed in more detail below. System 10 can be part of a larger system, such as a billing and revenue management system, charging system, or accounting system. Therefore, system 10 will typically include one or more additional functional modules 18 to include the additional functionality. In one embodiment, additional functionality 18 is provided by “Oracle Communications Elastic Charging Engine” by Oracle Corp. A database 17 is coupled to bus 12 to provide centralized storage for modules 16 and 18 and store one or more data sets to support contextual data processing, etc. Some embodiments may not include all of the elements in FIG. 1.

Billing and revenue management systems are used in support of billing activities. As part of a billing and revenue management system, typically, a charging system allocates usage to some cost per quantity usage metric. Known charging systems will separate usage charges based on time period rules, such as off-peak and on-peak times. However, in some cases, a seller or service provider will want to offer service under a tiered charging system that can alter the billed amount based on a promotion or surcharge related to the usage characteristics. A charging plan will provide the parameters for the alterations. Known tiered charging systems use traditional programming approaches to apply alterations according to a charging plan. This requires logic to be written in order to achieve accurate results for all complex use cases of altering charges. As such, known tiered charging systems generally rely on intermediate calculations to apportion charges to various discount ranges, thereby increasing the complexity of the implementation.

For example, a mobile phone provider may offer a plan that includes 700 min. of calling time, 300 MB of data transfer, and 200 text messages per month. For charges in excess of 700 min., the cell phone provider may charge $0.30 per minute for the first 100 min. over (701 to 800 min.), $0.20 per minute for the next 100 min. (801 to 900 min.), and $0.10 per minute thereafter. For charges in excess of 300 MB of data transfer, the cell phone provider may charge $15 for each additional block of 300 MB (301 to 600 MB, then another $15 for 601 to 900 MB, etc.). For charges in excess of 200 text messages per month, the cell phone provider may charge $0.10 for every text message and $0.20 for every photo or video message. To calculate the charge for a bill with 852 minutes, the provider would have to account for how many minutes are included in the plan, how many minutes are used in the next tier, and how many minutes are used in the third tier. To do so the provider may take 852 and subtract the plan minutes of 700, leaving 152, then subtract the next tier minutes of 100, leaving 52, and multiplying the minutes by the respective excess usage fees and adding them up accordingly. While this simple example is not overly complex, adding rules and algorithms to account for 100 plan variations, each with other promotional features such as off-peak calling, mobile to mobile calling, off-peak data access, etc. is cumbersome under known systems. In contrast, embodiments of the present invention can do so in a stateless way, without relying on other calculations executed for the same rule. In other words, the calculations for one step do not take the results of a calculation from another step as an input. The calculations act directly on the input charge periods without consideration to any charges already apportioned.

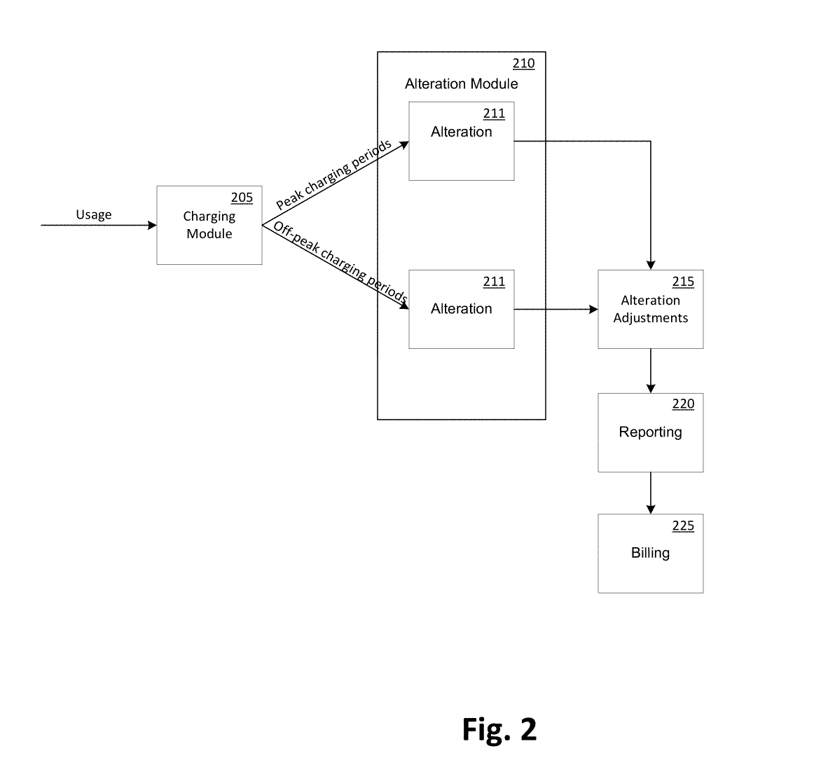

FIG. 2 is a block diagram illustrating the operational flow in accordance with one embodiment. Usage information is received by a charging module 205, for example, in conjunction with a billing and revenue management system. Charging module 205 determines how charging information should be presented for alteration. For example, for a telephone billing system, charging module 205 may split the charge up when a call spans a transition point from peak to on-peak charge rates. Therefore, if non-peak starts at 9:00 PM, a call that starts at 8:45 PM and lasts until 9:15 PM may be split into two different charge periods. Additional charge periods may be presented by charging module 205 if charging module 205 divides a single call into multiple sections based on different charging attributes; each section could be charged using a different rate plan. For example, charging module 205 may determine that a call lasted from 8:45 PM to 9:15 PM but only 26 minutes in duration was rated resulting in multiple charge periods between 8:45 PM to 8:55 PM, 8:59 PM to 9:00 PM and 9:00 PM to 9:15 PM. Additional charge periods could also be presented based on some logic in charging module 205 that provides charge periods over gaps. For example, unrated (not charged) portions of a call due to configuration or unavailability of plan data may be provided in their own charge periods or may be exempted altogether. Certain charge periods may be filtered out of alteration based on other pre-configured attributes in charging module 205.

Charging module 205 sends the charge periods for alteration to alteration module 210. Alteration module 210 contains various alteration profiles or rate plans (211) and determines which charging periods should be altered based on an alteration rule. Adjustments are made at 215 to change the values of each of the charges corresponding to the identified charge periods for alteration. At 220, the results of the charges and corresponding alterations are reported back to a billing and revenue management or similar service. At 225, billing receives the information to process and generate bills for the usage.

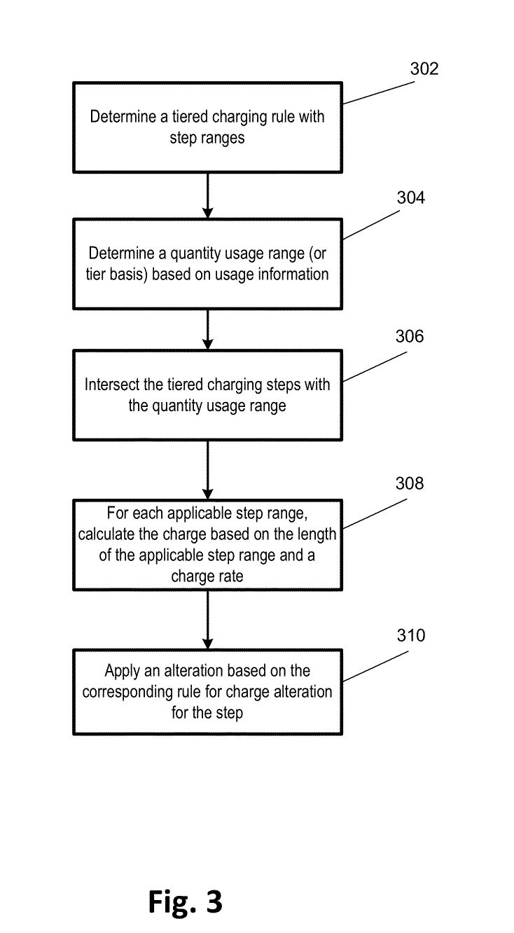

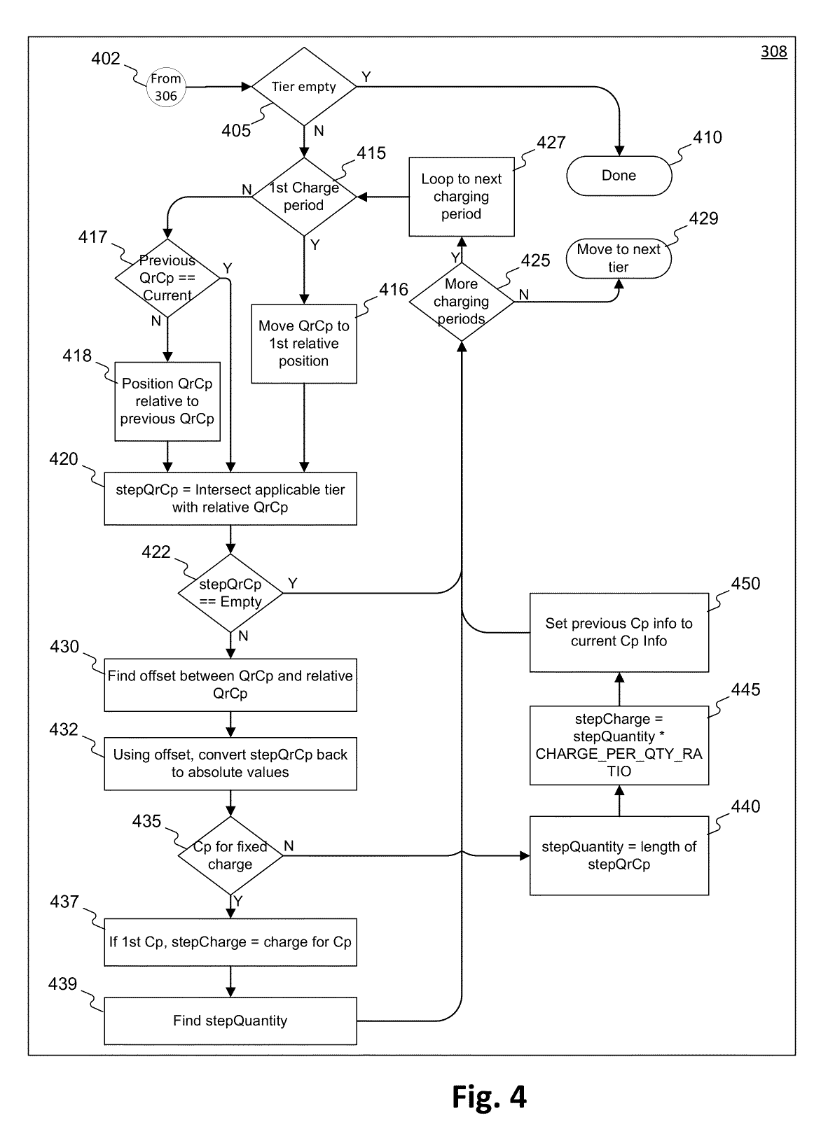

FIG. 3 is a flow diagram of the functionality of the tiered charging alteration management module 16 of FIG. 1 when processing charging events in accordance with one embodiment. Elements 302 through 308 correspond to 210 of FIG. 2. Element 310 corresponds to 215 of FIG. 2. In one embodiment, the functionality of the flow diagram of FIG. 3, and FIGS. 4 and 5 below, is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 302, module 16 determines a tiered charging rule with step ranges. A tiered charging rule may consider the first thirty minutes of total off-peak usage for alteration under the rule that “for the first 15 minutes of off-peak usage provide a 10% discount, for the next 15 minutes of off-peak usage provide a 20% discount, and for any remainder proved a 35% discount.” This defines the tier basis. Module 16 will determine corresponding range values for the rule, in this case, the ranges [0, 15], [15, 30], and [30, INF] (where INF=infinity). Each of these ranges represents a step or tier within a tiered charging rule. In this example, these steps will only be evaluated if the incoming usage information is for off-peak charge periods. Using intersection of ranges complements the functional programming using Domain Specific Language (“DSL”), thereby allowing a more efficient implementation in both preparation and execution.

At 304, information related to the charging periods will be received, including a quantity associated with the charging periods. From the quantity, a quantity range will be created. The quantity range will go from the start of the first step to the length of the quantity. In the example above, the quantity range would be [0, 0+quantity]. So, in accordance with the above example, for a quantity billed of 50 minutes, the quantity range found would be [0, 50].

At 306, the first step is intersected with the quantity range to find the applicable step range. In the example, the quantity range [0, 50] would be intersected with the first step [0, 15], resulting in the range [0, 15]. Thus the quantity range [0, 50] is algorithmically determined to cover the entire scope of the first step. When the second step is evaluated at 306, [0, 50] will be intersected with [15, 30], resulting in the applicable step range of [15, 30]. When the third step is evaluated at 306, [0, 50] will be intersected with [30, INF], resulting in the range [30, 50].

At 308, for each applicable step range, the charge for the step can be calculated based on the length of each applicable step range and a charge rate. In the example, the first step range, [0, 15] has a length of 15. The length of 15 can be multiplied by the linear or per unit charge rate to determine a tier charge amount. The rule can also encompass a flat rate charge as well. For example, if the rule also adds a flat-rate per call charge as well of $0.50, then the flat rate can be charged for the first charge period only.

At 310, an alteration is applied to the tier charge amount based on the corresponding rule for charge alteration for the step. In the example, the first tier charge would be discounted by 10%, second by 20%, and third by 35%. Once the portion of the usage is attributed to each step, then applying the alterations amounts to mapping the alterations to each step. In some embodiments, these tier alterations can alternatively be applied to the per unit charge rate in 308. The tier and alteration information can be further passed along to a reporting 220 and billing system 225 for providing bills to the user's or other responsible party.

One skilled in the art will appreciate that the loop over each of the steps in 306 can be altered to include step 308, so that elements 306 and 308 execute for each step. In cases where there are more steps than the quantity range covers, then execution can be stopped when there is no intersection between the quantity range of the usage and the applied step. Element 310 can likewise be brought into the loop evaluating all of the steps in the rule. By evaluating each step independently, any evaluations over other steps does not affect the evaluation of the current step. Thus, such execution for each step has the advantage of being stateless.

In some embodiments, as explained above with respect to an example rule that may have gaps in the duration of a charging event due to portions that are either unrated or rated under different charging plans, multiple charge periods may be provided by charging module 205. Thus, a quantity may have different charge periods associated with the quantity. Although the quantity controls how the alterations are applied to the step ranges, for the purposes of billing, it may be desirable for the charge periods to be accounted for individually so that the proper alteration is applied to each charge period and that information can be properly tracked in reporting 220 and billing 225. For example, another billing arrangement may consider all usage activity within a 24 hour period as a single billable event and arrange that individual access periods be passed as charge periods. For known billing systems, this would be solved by complicated programming to combine and redistribute the charges especially across multiple variations of charging and alteration plans; to accommodate all complex variations in charging and alteration rate plans any changes to the plans would likely necessitate reprogramming and testing. The programming for these various use cases becomes complex in known systems.

Whereas special programming is typically needed with prior art billing systems to deal with these types of billing arrangements—where breaks can occur in charging periods over one billing event—embodiments of the present invention handle this information just as if the charging period were one simple contiguous period. Moreover, the system and process described herein accomplish complex billing arrangements efficiently so that thousands of billing records can be processed quickly. Further, because embodiments are stateless from the process of one step to another, the processing can be accomplished in parallel on multiple computers or Central Processing Unit cores using known techniques.

FIG. 4 is a flow diagram of the functionality of the tiered charging alteration management module 16 of FIG. 1 when processing charging events having multiple charge periods in accordance with one embodiment. FIG. 4 further depicts element 308 of FIG. 3 in accordance with some embodiments. As described above, at 302 a tiered charging rule is determined along with step ranges for each of the tiers. At 304, a quantity usage range is determined based on the total usage for the charge. At 306, the quantity usage range is intersected with the step ranges for the tier under consideration. Execution moves to FIG. 4 starting at 402. At 405, each tier of the rule is considered in turn, but when the tier is empty, meaning the tier rules have exceed the quantity range under consideration, further processing of additional tiers would be unnecessary. At 410, the tier was determined to be empty, so execution completes and can move to 310 of FIG. 3. At 415, the flow begins to examine the charge periods associated with the usage. Each charge period has a quantity range associated with it, a charge period quantity range (“QrCp”). In some embodiments, if the lengths of the charge period quantity ranges were summed, they would equal the length of the quantity usage range as described above. In some embodiments, the lengths of the charge period quantity ranges may not sum to equal the length of the quantity usage range, because the quantity usage range may be affected by the tier basis which may specify an initial alteration that adjusts the quantity usage range. The QrCp may be eligible for a portion of the total alteration as determined by the applicable quantity step range in 308. The QrCp may represent a fixed charge as well as a linear charge, so sometimes the QrCp may be duplicative of another charge period, but indicate that it should be processed as a fixed fee for the charge. Thus, charge periods may represent either linear fees or fixed fees, and both types of fees may be present.

At 415, the charge period is examined to determine whether it is the first charge period under consideration. If so, at 416, the QrCp is moved to a first position to begin arranging the charge periods relative to one another. This can be done by setting the first value of a relative charge period quantity range (“relQrCp”) to zero and the second value of the relQrCp to the length of the QrCp. For clarity, the original QrCp can be also be known as an absolute charge period quantity range (“absQrCp”). If the charge period is not the first one, at 417, the QrCp of the previous charge period considered (“prevQrCp”) is compared to the absQrCp of the current charge period. If these are the same, then the system considers that one of them was a fixed fee charge period and the other is a linear fee charge period. One of them is therefore ignored for the purposes of positioning the charge periods relative to each other. At 418, if the prevQrCp is different than the current absQrCp, the absQrCp is positioned relative to the previous one by setting the first value of the relQrCp to the end value of the prevQrCp and setting the second value to the first value plus the length of the current absQrCp.

At 420, a charge period quantity range for the step (“stepQrCp”) is found by intersecting the applicable tier range with the relQrCp. This finds the portion of the QrCp attributable to the current step. Doing this helps find the proper apportionment of the charges in instances where the relQrCp will span to another tier. If at 422, stepQrCp is empty, then the charge period under consideration does not have relative values that fall within the tier or step under consideration, and the flow will loop back to 425 to determine if there are any more charging periods to consider. If there are more charging periods to consider, then at 427, flow will loop to the next charging period and begin again at 415. If there are no more charging periods to consider, then flow will move to the next tier at 429. In some embodiments, 429 will flow to 310, while in others 429 may flow to 306, depending on when alterations are applied for the evaluated tiers. If stepQrCp is not empty, then at 430 an offset is found between the absQrCp and stepQrCp and, at 432, the offset is used to anchor the stepQrCp absolute within the absQrCp. This can be done by adding the offset to the start and end values of stepQrCp.

At 435, if the charging period is designated for a fixed charge, then at 437, if it is the first charging period for the step, the step charge equals the charge for the charge period. If it is not the first charging period for the step, then there is no additional step charge for another fixed charge in the step. At 439, the quantity attributable for the entire step is found. If this were a linear charge, the quantity attributable for each charge period may be desirable, but because it is a fixed charge, then the quantity for the fixed charge for the whole step may be found. If the quantity associated with the charging period is zero, then the charging period range can be represented by a zero-length range, such as [30, 30] for a fixed fee charging period beginning at the 30th minute. If the quantity is not zero, as for subsequent charging periods in the step, then the step quantity range is simply the quantity range for the step because the fixed charge applies to the entire step for all charging periods. In both cases, the step charge is applied only once for the step. At 425, flow continues to consider if there are additional charging periods, as described above.

Turning back to 435, if the charging period is for a linear charge, then the system can calculate, at 440, the step quantity of the charging period applying to the current step by finding the length of stepQrCp. At 445, a step charge is found by multiplying the step quantity by a charge per quantity ratio. The charge per quantity ratio can be a fixed fee per unit cost of the commodity in use. At 450, the prevQrCp is set to the current absQrCp. At 425, the flow considers whether there are any more charging periods to consider, as described above. If not, then at 429, the flow will move to the next tier. In some embodiments, alterations may be made at 445 by either applying them to the step charge or adjusting the charge per quantity ratio accordingly. In such embodiments, flow element 310 may effectively be merged into element 445 at that point.

An example of the flow will be considered in relation to some sample data for the purposes of clarifying the flow. One skilled in the art will understand that this example is illustrative only and can be altered to accommodate particular billing needs at will.

Consider an tiered altering rule with five tiers for billing data usage defined as follows: for any 24 hour period data usage up to 50 MB is $0.20 per MB, data usage from 50 MB to 100 MB is $0.15 per MB, data usage from 100 MB to 150 MB is $0.10 per MB, data usage from 150 MB to 200 MB is $0.30 per MB, data usage from 200 MB to 400 MB is free, and data usage from 400 MB and up is $0.15 per MB. The base fee is defined as $0.20 per MB. At 302, the rule can be expressed in step tier ranges as follows:

| Step/Tier | Range | Alteration |
|---|---|---|
| 1 | [0, 50] | 100% of base fee |
| 2 | [50, 100] | 75% of base fee |
| 3 | [100, 150] | 50% of base fee |
| 4 | [150, 200] | 150% of base fee |
| 5 | [200, 400] | 0% of base fee |
| 6 | [400, INF] | 75% of base fee |

In this example, the charging system only bills for downloads per 24 hour period, but only from 8:00 AM to 9:30 AM, from 12:00 PM to 1:30 PM, and from 4:00 PM to 5:30 PM. A user's activity totaling 300 MB of billable download activity is as follows:

| CP | Time | Quantity Range | Quantity | Fixed/Linear |
|---|---|---|---|---|
| 1 | 8:00-8:10 | [20, 85] | 65 | Linear |
| 2 | 9:00-9:10 | [120, 130] | 10 | Linear |
| 3 | 12:00-12:10 | [300, 355] | 55 | Linear |
| 4 | 13:00-13:10 | [430, 490] | 60 | Linear |
| 5 | 17:00-17:10 | [500, 610] | 110 | Linear |

At 304, a quantity range is found as [0, 300]. At 306, intersecting the quantity range with the tiers yields the following:

| Range | Intersection with [0, 300] |
|---|---|
| [0, 50] | [0, 50] |
| [50, 100] | [50, 100] |
| [100, 150] | [100, 150] |
| [150, 200] | [150, 200] |
| [200, 400] | [200, 300] |
| [400, INF] | None |

At 308 then 405, for the first step, the system determines whether the tier is empty. It is [0, 50], so it is not empty. Starting with the first charge period at 8:00-8:10, at 415, the system considers whether this is the first charge period. It is, so at 416, the system moves the QrCp, [20, 85] to a first relative position by taking the first value to be zero and the second to be the length (65), relQrCp=[0, 65]. At 420, stepQrCp=[0, 50] intersect [0, 65]=[0, 50]. At 422, stepQrCp is not empty. At 430, the offset is found as (QrCp.first−relQrCp.first)=(20−0)=20. At 432, converting stepQrCp back to absolute values, [0, 50]+20=[20, 70]. At 435, the charging period is not a fixed fee, so at 440, the step quantity=the length of stepQrCp=70−20=50. The step charge is the step quantity times the base charge, $0.20 per MB, so the step charge=50*0.20=$10.00. At 450, prevQrCp is set to [20, 85]. The value for relQrCp is still set to [0, 65]. At 425, the system considers whether there are any more charging periods. There are so at 427, the system loops to the next charging period.

For the first tier still, in the second charging period at 415, the system considers whether it is the first charging period. It is not; at 417, the system considers whether the charging period values for the current charging period ([120, 130]) are the same as the previous charging period ([20, 85]) are the same. They are not; the system at 418 positions QrCp relative to the previous QrCp by using the previous relQrCp value: relQrCp=[relQrCp.last, relQrCp.last+QrCp.length]=[65, 75]. At 420, the system intersects the relQrCp with the applicable tier ([0, 50]): stepQrCp=[65, 75] intersect [0, 50]=0. At 422, the system considers whether stepQrCp is empty. It is, so the system moves to 425 to consider whether there are any more charging periods. There are, so the system processes them in order. But those skilled in the art will see that no other intersections occur for the first tier in this example. The system examines every charging period because there is no guarantee that the charging periods will come in any particular order.

For the next tier, the system will intersect the tier step value [50, 100] with the quantity range [0, 300] to find the applicable step. Doing so yields [50, 100]. The tier is not empty, so the system will consider the first charge period [20, 85]. This will be moved to the first relative position to find the relQrCp=[0, 65]. relQrCp is intersected with the applicable tier to find stepQrCp=[0, 65] intersect [50, 100]=[50, 65]. This is not empty, so an offset will be found between the QrCp and the relQrCp=20. Converting stepQrCp back to absolute values yields [50, 65]+offset=[70, 85]. The step quantity is found by the length of stepQrCp=15. The step charge is the step quantity times the base charge=15×$0.20=$3.00. An alteration will be applied on this in accordance with the rule for the second step: 75%×$3.00=$2.25.

Next, the second charge period will be considered, as before. As before, relQrCp=[65, 75]. Intersection with the step yields [65, 75]. The offset=120−65=55. So the adjusted stepQrCp=[120, 130]. The step quantity is the length=10, and the step charge=the base fee times the quantity=0.20×10=$2.00. After alteration, the fee will be 75% of $2.00=$1.50.

The third charge period will be considered. The relative range for the third charge period=relQrCp=[75, 130]. Intersection with the applicable second tier range yields stepQrCp=[75, 100]. Here, the offset=300−75=225. Adjusting stepQrCp back to absolute values=[300, 325]. The length is 25. Multiplied by the base fee, 25×$0.20=$5.00. An alteration will be applied on this in accordance with the rule for the second step: 75%×$5.00=$3.75.

The fourth charge period will be considered, but none of the charge period falls within the second tier. The flow will continue until all of the charge periods have been fully considered against all the tiers in the charging rule. Skipping ahead to the fourth step, it is shown that in this case the alteration actually increases the price. A table reflecting the resulting breakdown of charges to tiers is as follows:

| CP | Tier | Quantity Range | Quantity | Base Charge | Altered Charge |
|---|---|---|---|---|---|
| 1 | 1 | [20, 70] | 50 | 10.00 | 10.00 |
| 1 | 2 | [70, 85] | 15 | 3.00 | 2.25 |
| 2 | 2 | [120, 130] | 10 | 2.00 | 1.50 |
| 3 | 2 | [300, 325] | 25 | 5.00 | 3.75 |
| 3 | 3 | [325, 355] | 30 | 6.00 | 3.00 |
| 4 | 3 | [430, 450] | 20 | 4.00 | 2.00 |
| 4 | 4 | [450, 490] | 40 | 8.00 | 12.00 |
| 5 | 4 | [500, 510] | 10 | 2.00 | 3.00 |
| 5 | 5 | [510, 610] | 100 | 20.00 | 0.00 |

Although this example is illustrative of the concepts of how the system uses range values and intersection to determine alteration periods for a stepped alteration rule, one skilled in the art will understand that other values will result in a different execution. However, because of the algorithmic solution involving range intersection, charging information can be received and apportioned quickly and efficiently and without requiring the processing from one tier to be used in the processing of another tier.

Psuedocode for some embodiments is provided below. One skilled in the art will understand that certain elements of the pseudocode can be done in different ways programmatically without altering the end functionality, including executing blocks in different order, taking some elements out of loops, putting some elements into loops, etc.

Notations for the Psuedocode:

Qr=quantity range [start, end] where start and end values are decimals.
tierBasisQr=[0, absolute(tier basis value)], quantity usage range
stepQr=[absolute(start), absolute(end)], quantity range for a step
applicableTierQr=applicable tier quantity range for the step
Cp=charge period associated with the usage
QrCp=quantity range in a charge period
absQrCp, prevQrCp, relQrCp=absolute and relative quantity ranges, absolute corresponding to the original quantity range from a billing system, and relative corresponding to a relative positioning of a quantity range to a step or other quantity ranges
offset=the offset between the absolute and relative value for a Qr
stepQrCp=step quantity range in a charge period
stepCharge=proportional alterable charge per charge period
stepQuantity=proportional alterable quantity per charge period
Fixed charge=charge is a constant for the whole quantity (e.g. 2$ fixed charge)
Linear charge=charge varies with the quantity (10 cents/MB)
CHARGE_PER_QTY_RATIO=Charge per unit of quantity [Constant for each charge period]. Thus, the charge for a particular quantity associated with a charge period can differ from charge period to charge period, even if the alteration applied to each charge period within a step is the same. One skilled in the art will recognize, however, that the execution could be altered to vary the CHARGE_PER_QTY_RATIO directly based on the rules for the step.

Psuedocode:

For each step:
1: Get the tier basis quantity range tierBasisQr from the tier basis value, the quantity
value from the charging system.
2: Convert the start and end values of the step into a step quantity range stepQr.
3: Intersect the tier basis range with the step range to get the quantity range applicable
to the step.

applicableTierQr = tierBasisQr INTERSECT stepQr

4. IF applicableTierQr is not empty THEN

4a: IF applicableTierQr.endValue = tierBasisQr.endValue THEN

Mark it as ′Fully evaluated” /* entire tier basis has been consumed. No
more steps to be evaluated after this step*/

END IF;
4b: Proportionally distribute the applicable quantity for the step across multiple
charge periods.
For each charge period (“Cp”) Do

4b1: Convert the QrCp from absolute to relative values to take care of
gaps in the charge period's quantity range
absQrCp = QrCp /* quantity range in absolute values */
IF ( first charge period ) THEN

relQrCp = [0, absQrCp.LENGTH]

ELSE

/* if current and previous quantity ranges are same ( this can
happen when there is a fixed charge and a linear charge for the
same quantity ), use the previous relative quantity range, no need
to recalculate */
IF ( absQrCp != prevQrCp ) THEN

IF ( absQrCp.startValue >= prevQrCp.endValue ) THEN /*
create next consecutive quantity range from the previous
range's end value */

relQrCp = [ relQrCp.endValue, relQrCp.endValue +
absQrCp.LENGTH]

ELSE /*corner case when quantity ranges are like [0, 30],
[0, 25] */

relQrCp = [ relQrCp.startValue, relQrCp.startValue +
absQrCp.LENGTH]

ENDIF

ENDIF

ENDIF
4b2: Intersect the applicable quantity range with charge period's quantity
range (in relative values)
stepQrCp = applicableTierQr INTERSECT relQrCp
IF stepQrCp is not Empty THEN /* means there is some intersection with
the charge period */

offset = absQrCp.start − relQrCp.start
/* convert it back to absolute values in the final result */
stepQrCp = [ stepQrCp.startValue + offset, stepQrCp.endValue +
offset ]
4b21: Entire fixed charge has to be considered at the first instant of
the quantity
IF ( Cp is for a fixed charge) THEN

4b211: IF ( stepQrCp.startValue = relQrCp.startValue)
THEN /*during the first instant, the whole charge is
considered */

stepCharge = Cp.charge

ELSE /* if not the first instant, the charge is not re-
considered */

SKIP; /*do not double count this charge since it is
already applied at the first instant*/

END IF
4b212: Get the corresponding Step Qty Range
IF ( Cp.quantity == 0) THEN

stepQrCp = [absQrCp.startValue,
absQrCp.startValue] /*make start and end values as
same since it is for the first instant of the quantity */

ELSE /* if not first instant, then the charge period's quantity
range is kept although there is no charge against it */

stepQrCp = absQrCp

END IF
stepQuantity = stepQrCp.LENGTH

ELSE /* for linear charges */

4b211: stepQuantity = stepQrCp.LENGTH
4b212: stepCharge = stepQuantity x
CHARGE_PER_QTY_RATIO /*calculate proportional
charge from the quantity to maintain linearity*/

END IF
prevQrCp = absQrCp // reset the absQrCp

ENDIF [stepQrCp is not Empty]

END // End For loop
ENDIF [applicableTierQr is not Empty]

As disclosed, embodiments receive charging periods based on charging events for services and a total usage quantity, deriving a usage quantity range. The system finds range values for each step of a tiered charge alteration rule. The system intersects the quantity range the tiers to determine an applicable range for each step. Then, the system analyzes each charge period to find the portion of the charge period that applies to each applicable step. Finally, the system determines a charge for the usage of the charging period falling within the tier, enabling alterations to be applied to each of step charges according to the alteration rules for the step.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium with instructions stored thereon to alter charges for a billing event in a real time charging domain, the altering comprising:
determining a tiered charging rule with at least one step, each step comprising a numerical range defining quantity entry values and exit values, wherein each step corresponds to a rule for charge alteration;
determining a quantity usage range corresponding to usage that generates a billing event, wherein the quantity usage range defines starting values and ending values for the usage considered for alteration;
intersecting each step with the quantity usage range to determine applicable steps for the quantity usage range;
for each applicable step:
calculating a step charge based on a length of the applicable step range and a base per unit charge rate; and
applying an alteration based on the corresponding rule for charge alteration for the step.

2. The computer readable medium of claim 1, wherein the quantity usage range relates to multiple charge periods for the billing event, the altering further comprising:
for each applicable step for each charge period:
calculating a relative usage range for the charge period based on length of the usage range, wherein the relative usage range defines a starting value and an ending value relative to other charge periods; and
intersecting the applicable step range with the relative usage range to determine an applicable step usage range, wherein the calculation of the step charge for the charge period is based on the length of the applicable step usage range and the base per unit charge rate.

3. The computer readable medium of claim 2, wherein the altering further comprises, for each applicable step for each charge period:
calculating an offset between the usage range and relative usage range; and
applying the offset to the applicable step usage range to find absolute usage range for the charge period, wherein the calculation of the step charge for the charge period is based on the length of the absolute usage range and the base per unit charge rate.

4. The computer readable medium of claim 2, wherein the calculation of the relative usage range for the charge period defines the starting value as the end value of the previously considered charge period of the multiple charge periods.

5. The computer readable medium of claim 2, wherein the altering further comprises:
for each applicable step for each charge period:
calculating a fixed charge when the start value of the relative usage range equals the start value of the applicable step range.

6. The computer readable medium of claim 1, further comprising:
reporting the usage attributable to each step to a reporting and billing system.

7. The computer readable medium of claim 1, wherein the calculations for one step do not depend on the calculations for another step.

8. A computer implemented method of altering charges for a billing event in a real time charging domain comprising:
determining, by the computer, a tiered charging rule with at least one step, each step comprising a numerical range defining quantity entry values and exit values, wherein each step corresponds to a rule for charge alteration;
determining, by the computer, a quantity usage range corresponding to usage that generates a billing event, wherein the quantity usage range defines starting values and ending values for the usage considered for alteration;
intersecting, by the computer, each step with the quantity usage range to determine applicable steps for the quantity usage range;
for each applicable step:
calculating, by the computer, a step charge based on a length of the applicable step range and a base per unit charge rate; and
applying, by the computer, an alteration based on the corresponding rule for charge alteration for the step.

9. The method of claim 8, wherein the quantity usage range relates to multiple charge periods for the billing event, further comprising:
for each applicable step for each charge period:
calculating a relative usage range for the charge period based on length of the usage range, wherein the relative usage range defines a starting value and an ending value relative to other charge periods; and
intersecting the applicable step range with the relative usage range to determine an applicable step usage range, wherein the calculation of the step charge for the charge period is based on the length of the applicable step usage range and the base per unit charge rate.

10. The method of claim 9, further comprising, for each applicable step for each charge period:
calculating an offset between the usage range and relative usage range; and
applying the offset to the applicable step usage range to find absolute usage range for the charge period, wherein the calculation of the step charge for the charge period is based on the length of the absolute usage range and the base per unit charge rate.

11. The method of claim 9, wherein the calculation of the relative usage range for the charge period defines the starting value as the end value of the previously considered charge period of the multiple charge periods.

12. The method of claim 9, further comprising:
for each applicable step for each charge period:
calculating a fixed charge when the start value of the relative usage range equals the start value of the applicable step range.

13. The method of claim 8, further comprising:
reporting the usage attributable to each step to a reporting and billing system.

14. The method of claim 8, wherein the calculations for one step do not depend on the calculations for another step.

15. A system of altering charges for a billing event in a real time charging domain, comprising:
a tiered charging rule determiner for a tiered charging rule having at least one step, each step comprising a numerical range defining quantity entry values and exit values, wherein each step corresponds to a rule for charge alteration;
a quantity usage range determiner for a quantity usage range that generates a billing event, wherein the quantity usage range defines starting values and ending values for the usage;
a range intersector that intersects each step with the quantity usage range to determine applicable steps for the quantity usage range; and
a step charge calculator and an applicator, wherein for each applicable step:
the step charge calculator calculates a step charge based on a length of the applicable step range and a base per unit charge rate; and
the applicator applies an alteration based on the corresponding rule for charge alteration for the step.

16. The system of claim 15, wherein the quantity usage range relates to multiple charge periods for the billing event, further comprising:
a relative usage range calculator and an applicable step range intersector, wherein for each applicable step for each charge period:
the relative usage range calculator calculates a relative usage range for the charge period based on length of the usage range, wherein the relative usage range defines a starting value and an ending value relative to other charge periods; and
the applicable step range intersector intersects the applicable step range with the relative usage range to determine an applicable step usage range, wherein the calculation of the step charge for the charge period is based on the length of the applicable step usage range and the base per unit charge rate.

17. The system of claim 16, further comprising an offset calculator and offset applicator, wherein for each applicable step for each charge period:
the offset calculator calculates an offset between the usage range and relative usage range; and
the offset applicator applies the offset to the applicable step usage range to find absolute usage range for the charge period, wherein the calculation of the step charge for the charge period is based on the length of the absolute usage range and the base per unit charge rate.

18. The system of claim 16, wherein the calculation of the relative usage range for the charge period defines the starting value as the end value of the previously considered charge period of the multiple charge periods.

19. The system of claim 16, further comprising a fixed charge calculator, wherein for each applicable step for each charge period:
the fixed charge calculator calculates a fixed charge when the start value of the relative usage range equals the start value of the applicable step range.

20. The system of claim 15, further comprising:
a reporter that reports the usage attributable to each step to a reporting and billing system.

21. The system of claim 15, wherein the calculations for one step do not depend on the calculations for another step.
